(19) United States
(12) Patent Application Publication
(10) Pub. No.: US 2012/0081456 A1
(43) Pub. Date: Apr. 5, 2012

(54) Magenta Dyes and Inks for Use in Ink-Jet Printing

(75) Inventors: Clive Edwin Foster, Manchester (GB); Gavin Wright, Manchester (GB); Toshiki Fujiwara, Kanagawa (JP)

(73) Assignee: Fujifilm Imaging Colorants Limited, Manchester (GB)

(21) Appl. No.: 13/377,136

(22) PCT Filed: May 26, 2010
(86) PCT No.: PCT/GB10/50861

§ 371 Date: Dec. 8, 2011

(30) Foreign Application Priority Data
Jun. 23, 2009 (GB) 0910806.9

(51) Int. Cl. B41J 2/175; C09B 43/00; C09D 11/02; C09B 43/32

(52) U.S. Cl. 347/20; 534/593; 534/588; 106/31.48; 347/86; 347/105

(57) ABSTRACT

An oligomerised dye compound, and salts thereof, obtainable by a process which comprises reacting a compound of Formula (1) and salts thereof with a compound of Formula (2) and salts thereof

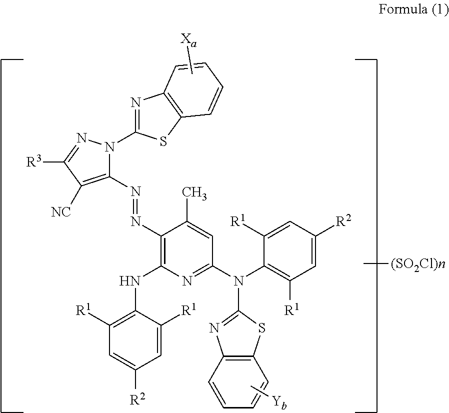

wherein:
R¹ and R² are independently H, optionally substituted alkyl, optionally substituted aryl or optionally substituted heteroaryl;
R³ is optionally substituted alkyl, optionally substituted aryl or optionally substituted heteroaryl;
X and Y are independently a substituent;
a+b=0 to 4;
n=1 to 6;

L-(NH₂)ₘ Formula (2)

wherein:
L comprises an optionally substituted, or optionally interrupted, aliphatic group, an optionally substituted aromatic group or an optionally substituted heterocyclic group; and
m is 2 to 4. Also compositions, inks, printing processes, printed materials and ink jet cartridges.

This invention relates to dyes, to compositions and inks for ink jet printers, to printing processes, to printed substrates and to ink jet printer cartridges.

Ink jet printing is a non-impact printing technique in which droplets of ink are ejected through a fine nozzle onto a substrate without bringing the nozzle into contact with the substrate. The set of inks used in this technique typically comprise yellow, magenta, cyan and black inks.

With the advent of high-resolution digital cameras and ink jet printers it is becoming increasingly common for consumers to print off photographs using an ink jet printer.

While ink jet printers have many advantages over other forms of printing and image development there are still technical challenges to be addressed. For example, there are the contradictory requirements of providing ink colorants that are soluble in the ink medium and yet display excellent wet-fastness (i.e. prints do not run or smudge when printed). The inks also need to dry quickly to avoid printed sheets sticking together, but they should not form a crust over the tiny nozzles in the printer head. Storage stability is also important to avoid particle formation that could block the printer nozzles, especially since consumers can keep an ink jet ink cartridge for several months. Furthermore, and especially important with photographic quality reproductions, the resultant images should not bronze or fade rapidly on exposure to light or common oxidising gases such as ozone. It is also important that the shade and chroma of the colorant are exactly right so that any image may be optimally reproduced.

A particular problem seen with some dyes, which is especially serious with ink jet dyes, is a tendency to foam. These foams cause severe problems both in ink manufacture and in use in the ink jet printers. This problem can render otherwise excellent colorants unusable.

Thus, developing new colorants for ink jet printing presents a unique challenge in balancing all these conflicting and demanding properties.

The present invention provides an oligomerised dye compound, and salts thereof, obtainable by a process which comprises reacting a compound of Formula (1) and salts thereof with a compound of Formula (2) and salts thereof

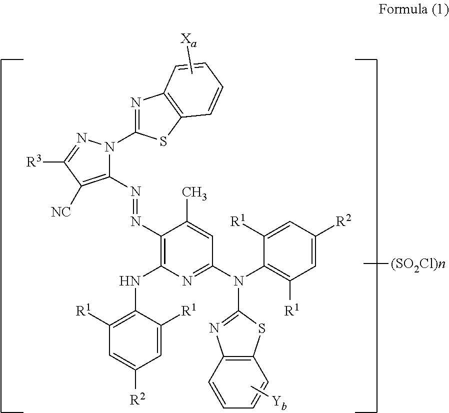

wherein:

R¹ and R² are independently H, optionally substituted alkyl, optionally substituted aryl or optionally substituted heteroaryl;

R³ is optionally substituted alkyl, optionally substituted aryl or optionally substituted heteroaryl;

X and Y are independently a substituent;

a+b=0 to 4;

n=1 to 6;

L-(NH₂)ₘ Formula (2)

wherein:

L comprises an optionally substituted, or optionally interrupted, aliphatic group, an optionally substituted aromatic group or an optionally substituted heterocyclic group; and

m is 2 to 4.

Preferably R¹ and R² are independently H or optionally substituted alkyl.

More preferably R¹ and R² are independently H or optionally substituted C₁₋₄alkyl. It is especially preferred that R¹ and R² are independently unsubstituted C₁₋₄alkyl.

Preferably R¹ is methyl or ethyl.

Preferably R² is methyl.

Preferably R³ is optionally substituted alkyl or optionally substituted aryl.

More preferably R³ is optionally substituted C₁₋₈alkyl (especially optionally substituted C₁₋₄alkyl) optionally substituted phenyl or optionally substituted naphthyl.

It is especially preferred that R³ is optionally substituted C₁₋₄alkyl and more especially unsubstituted C₁₋₄alkyl.

Preferably X and Y are independently selected from the group consisting of —Cl, —CN, —CF₃, —SO₂R⁴ wherein R⁴ is optionally substituted alkyl; optionally substituted aryl; or optionally substituted heterocyclyl.

More preferably X and Y are independently —Cl and —SO₂R⁴; and particularly —Cl.

Preferably X and Y are the same.

Preferably a is 0 or 1.

Preferably b is 0 or 1.

Preferably (a+b) is 0.

Preferably n is 4 to 6, more preferably 4 to 5 and especially 4.

The compounds of Formula (1) may be prepared using the processes as described in U.S. Pat. No. 7,108,743, which is incorporated herein by reference, to make the basic compound and then converting the pendent sulfonic acid groups into sulfonyl chlorides. It is expected that all the pendent sulfonic acid groups would be to converted to sulfonyl chlorides. After reaction with a compound of Formula (2) those sulfonyl chlorides which did not react with a compound of Formula (2) are preferably hydrolysed back to sulfonic acids. There is evidence that in some cases reaction with a chlorinating agent may affords an acid anhydride.

The skilled person will appreciate that n may be either an integer or an average depending on how the compounds of Formula (1) are prepared. Thus, if the compound of Formula (1) is prepared by coupling components carrying sulfonic acid substituents which are then converted to sulfonyl chlorides then n will be an integer. If the compound of Formula (1) is prepared by coupling components carrying no sulfonic acid substituents and this intermediate is then non-specifically sulfonated, using for example oleum, and then chlorinated the resultant product will be a mixture and n will be an average.

Conversion of the sulfonic acid groups to a sulfonyl chloride is conveniently achieved by reacting with, for example, chlorosulfonic acid and/or a chlorinating agent (e.g. POCl₃, PCl₅ or SOCl₂).

In the compounds of Formula (2) m is preferably 2 or 3 and more preferably 2.

When m is 2 then in the compounds of Formula (2) L preferably comprises; a linear, cyclic or branched optionally substituted C₁₋₂₀alkylene optionally interrupted with 1 to 8 hetero atoms (especially 1-4 hetero atoms), preferably the hetero atoms are N and/or O; optionally substituted phenylene; optionally substituted naphthylene; or an optionally substituted 5 to 8 membered heterocyclylene preferably with 1 to 3 hetero atoms wherein the hetero atoms are N and/or O. When L comprises an optionally substituted 5 to 8 membered heterocyclylene it is preferably selected from the group consisting of pyrazolylene, thiazolylene, triazolylene, pyridylene, pyrimidylene, triazylene and piperazylene.

Optional substituents which may be present on R¹, R², R³ and R⁴ when they are optionally substituted alkyl or L when it comprises an optionally substituted aliphatic group are preferably independently selected from: optionally substituted aryl (preferably optionally substituted phenyl), optionally substituted aryloxy (preferably optionally substituted phenoxy), optionally substituted heterocyclyl (including optionally substituted heteroaryl), polyalkylene oxide (preferably polyethylene oxide or polypropylene oxide), CO₂H, SO₃H, PO₃H₂, nitro, cyano, halo, ureido, —SO₂F, hydroxy, ester, sulphate, —NR^{a}R^{b}, —COR^{a}, —CONR^{a}R^{b}, —NHCOR^{a}, carboxyester, —SO₂R^{a}, —SO₂NR^{a}R^{b}, —S—R^{a}, —O—R^{a}, —NH—R^{a}, wherein R^{a}, R^{b} and R^{c} are each independently H, optionally substituted aryl (especially optionally substituted phenyl), optionally substituted alkyl (especially optionally substituted C₁₋₄-alkyl) or optionally substituted heterocyclyl. Optional substituents for any of the above substituents may be selected from the same list of substituents.

Optional substituents which may be present on R¹, R², R³ and R⁴ when they are optionally substituted aryl or optionally substituted heterocyclyl or L when it comprises an optionally substituted cyclic group are preferably independently selected from: optionally substituted alkyl (preferably optionally substituted C₁₋₄-alkyl); optionally substituted alkenyl (preferably optionally substituted C₁₋₄-alkenyl), optionally substituted alkynyl (preferably optionally substituted C₁₋₄-alkynyl), optionally substituted alkoxy (preferably optionally substituted C₁₋₄-alkoxy), optionally substituted aryl (preferably optionally substituted phenyl), optionally substituted aryloxy (preferably optionally substituted phenoxy), optionally substituted heterocyclyl (including optionally substituted heteroaryl), polyalkylene oxide (preferably polyethylene oxide or polypropylene oxide), CO₂H, SO₃H, PO₃H₂, nitro, cyano, halo, ureido, —SO₂F, hydroxy, ester, sulphate, —NR^{a}R^{b}, —COR^{a}, —CONR^{a}R^{b}, —NHCOR^{a}, carboxyester, —SO₂R^{a}, —SO₂NR^{a}R^{b}, —S—R^{a}, —O—R^{a}, —NH—R^{a}, wherein R^{a}, R^{b} and R^{c} are each independently H, optionally substituted aryl (especially optionally substituted phenyl), optionally substituted alkyl (especially optionally substituted C₁₋₄-alkyl) or optionally substituted heterocyclyl. Optional substituents for any of the above substituents may be selected from the same list of substituents.

Some preferred compounds of Formula (2) are shown in Table (1)

TABLE 1

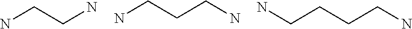

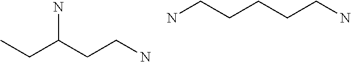

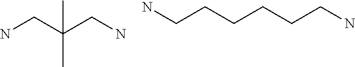

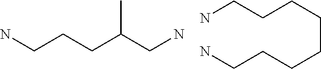

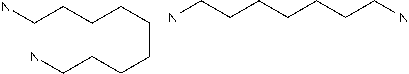

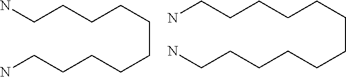

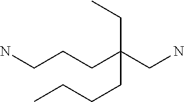

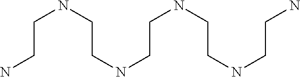

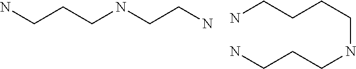

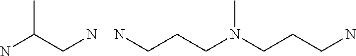

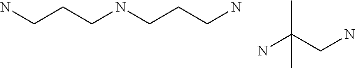

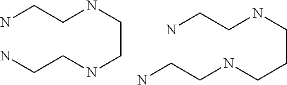

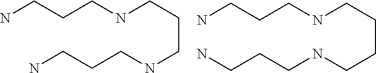

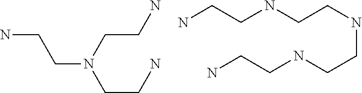

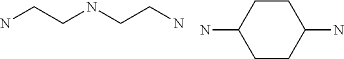

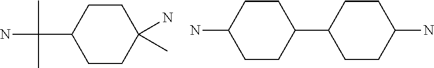

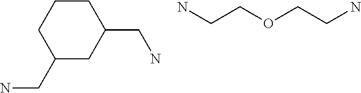

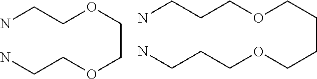

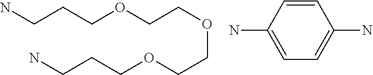

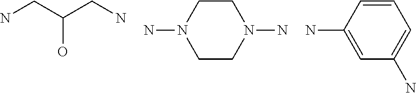

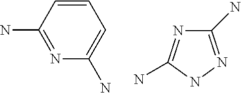

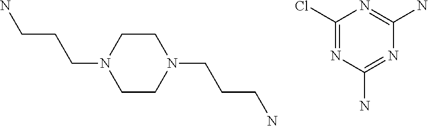

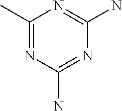

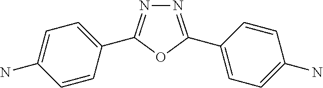

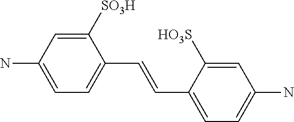

Preferably the oligomerised dye compound obtainable by the process of the invention has a weight average molecular weight in the range of 2000 to 20000 and more preferably in the range of 2000 to 10000. In an alternative embodiment the oligomerised dye compound obtainable by the process of the invention has a weight average molecular weight in the range of 1200 to 20000 and more preferably in the range of 1200 to 10000.

The preferred molar ratio of the compound of Formula (1) to that of Formula (2) depends to some extent on which specific compounds are used and on the reaction conditions.

However, preferably the oligomerised dye compound is obtainable by a process wherein the molar ratio of the compound of Formula (1) to that of the compound of Formula (2) is in the range of from 1 to 10 more preferably in the range of from 1 to 4 and especially in the range of from 1 to 2.

Preferably the reaction between the compound of Formula (1) and Formula (2) to yield the oligomerised dye compound is performed at a temperature in the range of from 0 to 80° C., more preferably in the range of from 5 to 40° C. and especially in the range of from 5 to 15° C. Cooler reaction temperatures are favoured when it is desired to avoid hydrolysis of the sulfonyl chloride groups in the compounds of Formula (1).

Preferably the reaction between the compounds of Formula (1) and Formula (2) to yield the oligomerised dye compound is carried out for a time in the range of from 0.5 to 24 hours, more preferably in the range of from 4 to 18 hours and especially in the range of from 12 to 16 hours.

The reaction time obviously depends on the temperature at which the reaction is carried out. Thus higher temperatures require less time and lower temperatures more time.

Preferably, although not always necessarily, the reaction between the compounds of Formula (1) and Formula (2) to yield the oligomerised dye compound is carried out in the presence of a solvent. Preferred solvents are methanol, tetrahydrofuran, dimethyacetamide, pyridine or dichloromethane.

The reaction between the compounds of Formula (1) and Formula (2) can optionally be performed in the presence of a base such as, for example, triethylamine or pyridine.

The oligomerised dye compound may be obtained as a precipitate. This precipitate may be isolated by standard methods, which would be familiar to a skilled person, followed by hydrolysis of any residual sulfonyl chloride groups. The final compound is then purified by, for example, washing in a suitable solvent and/or dialysis to remove low molecular weight contaminants.

In a particularly preferred embodiment the present invention provides an oligomerised dye compound, and salts thereof, obtainable by a process which comprises reacting a compound of Formula (1a) and salts thereof with a compound of Formula (2a) and salts thereof

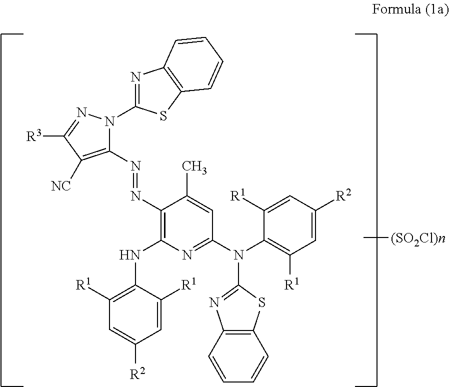

wherein:

R¹ and R² are independently H or optionally substituted C₁₋₄alkyl;

R³ is optionally substituted C₁₋₄alkyl, optionally substituted phenyl or optionally substituted naphthyl; and

n is 4 to 6;

L¹-(NH₂)₂ Formula (2a)

wherein:

L is a linear, cyclic or branched optionally substituted C₁₋₂₀alkylene optionally interrupted with 1 to 4 hetero atoms; optionally substituted phenylene; optionally substituted naphthylene; or an optionally substituted 5 to 8 membered heterocyclylene.

Preferences for R¹, R², R³ and L and preferred optional substituents are as described above.

Acid and basic groups on the oligomerised dye compound, particularly acid groups, are preferably in the form of a salt. Thus, the Formulae shown herein include the compounds in free acid and in salt form.

Preferred salts are alkali metal salts, especially lithium, sodium and potassium, ammonium and substituted ammonium salts (including quaternary amines such as ((CH₃)₄N⁺) and mixtures thereof. Especially preferred are salts with sodium, lithium, ammonia and volatile amines, more especially sodium salts.

The oligomerised dye compounds may be converted into a salt using known techniques.

Compounds of Formula (1), Formula (2), Formula (1a) and Formula (2a) and the oligomerised dye compounds may exist in tautomeric forms other than those shown in this specification. These tautomers are included within the scope of the present invention.

The oligomerised dye compounds, and salts thereof are valuable colorants for use in the preparation of ink jet printing inks, especially magenta inks. They benefit from a good balance of solubility, storage stability and fastness to ozone and light. In particular they display excellent ozone fastness. In addition the oligomerised dye compounds of the present invention show a reduced tendency to stabilise foams when compared to the corresponding unpolymerised dyes.

According to a second aspect of the present invention there is provided a process for preparing an oligomerised dye compound, and salts thereof, which comprises reacting a compound of Formula (1) and salts thereof with a compound of Formula (2) and salts thereof

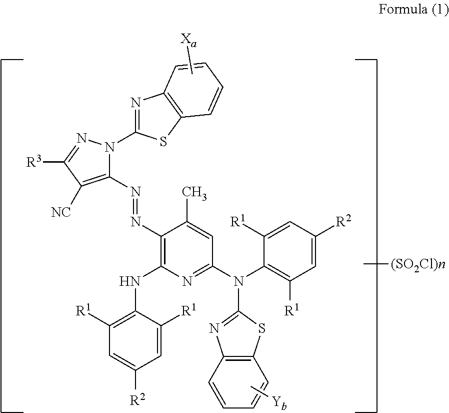

wherein:

R¹ and R² are independently H, optionally substituted alkyl, optionally substituted aryl or optionally substituted heteroaryl;

R³ is optionally substituted alkyl, optionally substituted aryl or optionally substituted heteroaryl;

X and Y are independently a substituent;

a+b=0 to 4;

n=1 to 6;

L-(NH₂)ₘ Formula (2)

wherein:

L comprises an optionally substituted, or optionally interrupted, aliphatic group, an optionally substituted aromatic group or an optionally substituted heterocyclic group; and

m is 2 to 4.

Preferences for the second aspect of the invention are as described in the first aspect of the invention.

According to a third aspect of the present invention there is provided a composition comprising an oligomerised dye compound, and salts thereof, as described in the first aspect of the invention, and a liquid medium.

Preferred compositions according to the third aspect of the invention comprise:
(a) from 0.01 to 30 parts of an oligomerised dye compound, and salts thereof according to the first aspect of the invention; and
(b) from 70 to 99.99 parts of a liquid medium;
   wherein all parts are by weight.

Preferably the number of parts of (a)+(b)=100.

The number of parts of component (a) is preferably from 0.1 to 20, more preferably from 0.5 to 15, and especially from 1 to 5 parts. The number of parts of component (b) is preferably from 80 to 99.9, more preferably from 85 to 99.5 and especially from 95 to 99 parts.

Preferably component (a) is completely dissolved in component (b). Preferably component (a) has a solubility in component (b) at 20° C. of at least 10%. This allows the preparation of liquid dye concentrates that may be used to prepare more dilute inks and reduces the chance of the dye precipitating if evaporation of the liquid medium occurs during storage.

The inks may be incorporated in an ink jet printer as a high concentration magenta ink, a low concentration magenta ink or both a high concentration and a low concentration ink. In the latter case this can lead to improvements in the resolution and quality of printed images. Thus the present invention also provides a composition (preferably an ink) where component (a) is present in an amount of 2.5 to 7 parts, more preferably 2.5 to 5 parts (a high concentration ink) or component (a) is present in an amount of 0.5 to 2.4 parts, more preferably 0.5 to 1.5 parts (a low concentration ink).

Preferred liquid media include water, a mixture of water and organic solvent and organic solvent free from water. Preferably the liquid medium comprises a mixture of water and organic solvent or organic solvent free from water.

When the liquid medium (b) comprises a mixture of water and organic solvent, the weight ratio of water to organic solvent is preferably from 99:1 to 1:99, more preferably from 99:1 to 50:50 and especially from 95:5 to 80:20.

It is preferred that the organic solvent present in the mixture of water and organic solvent is a water-miscible organic solvent or a mixture of such solvents. Preferred water-miscible organic solvents include C₁₋₆-alkanols, preferably methanol, ethanol, n-propanol, isopropanol, n-butanol, sec-butanol, tert-butanol, n-pentanol, cyclopentanol and cyclohexanol; linear amides, preferably dimethylformamide or dimethylacetamide; ketones and ketone-alcohols, preferably acetone, methyl ether ketone, cyclohexanone and diacetone alcohol; water-miscible ethers, preferably tetrahydrofuran and dioxane; diols, preferably diols having from 2 to 12 carbon atoms, for example ethylene glycol, propylene glycol, butylene glycol, pentylene glycol, hexylene glycol and thiodiglycol and oligo- and poly-alkyleneglycols, preferably diethylene glycol, triethylene glycol, polyethylene glycol and polypropylene glycol; triols, preferably glycerol and 1,2,6-hexanetriol; mono-C₁₋₄-alkyl ethers of diols, preferably mono-C₁₋₄-alkyl ethers of diols having 2 to 12 carbon atoms, especially 2-methoxyethanol, 2-(2-methoxyethoxy)ethanol, 2-(2-ethoxyethoxy)-ethanol, 2-[2-(2-methoxyethoxy)ethoxy]ethanol, 2-[2-(2-ethoxyethoxy)-ethoxy]-ethanol and ethyleneglycol monoallylether; cyclic amides, preferably 2-pyrrolidone, N-methyl-2-pyrrolidone, N-ethyl-2-pyrrolidone, caprolactam and 1,3-dimethylimidazolidone; cyclic esters, preferably caprolactone; sulfoxides, preferably dimethyl sulfoxide; and sulfones, preferably sulfolane. Preferably the liquid medium comprises water and 2 or more, especially from 2 to 8, water-miscible organic solvents.

Especially preferred water-miscible organic solvents are cyclic amides, especially 2-pyrrolidone, N-methyl-pyrrolidone and N-ethyl-pyrrolidone; diols, especially 1,5-pentane diol, ethyleneglycol, thiodiglycol, diethyleneglycol and triethyleneglycol; and mono-C₁₋₄-alkyl and C₁₋₄-alkyl ethers of diols, more preferably mono-C₁₋₄-alkyl ethers of diols having 2 to 12 carbon atoms, especially 2-methoxy-2-ethoxy-2-ethoxyethanol.

When the liquid medium comprises organic solvent free from water, (i.e. less than 1% water by weight) the solvent preferably has a boiling point of from 30 to 200° C., more preferably of from 40 to 150° C., especially from 50 to 125° C. The organic solvent may be water-immiscible, water-miscible or a mixture of such solvents. Preferred water-miscible organic solvents are any of the hereinbefore-described water-miscible organic solvents and mixtures thereof. Preferred water-immiscible solvents include, for example, aliphatic hydrocarbons; esters, preferably ethyl acetate; chlorinated hydrocarbons, preferably CH₂Cl₂; and ethers, preferably diethyl ether; and mixtures thereof.

When the liquid medium comprises a water-immiscible organic solvent, preferably a polar solvent is included because this enhances solubility of the dyes in the liquid medium. Examples of polar solvents include C₁₋₄-alcohols.

In view of the foregoing preferences it is especially preferred that where the liquid medium is organic solvent free from water it comprises a ketone (especially methyl ethyl ketone) and/or an alcohol (especially a C₁₋₄-alkanol, more especially ethanol or propanol).

The organic solvent free from water may be a single organic solvent or a mixture of two or more organic solvents. It is preferred that when the liquid medium is organic solvent free from water it is a mixture of 2 to 5 different organic solvents. This allows a liquid medium to be selected that gives good control over the drying characteristics and storage stability of the ink.

Liquid media comprising organic solvent free from water are particularly useful where fast drying times are required and particularly when printing onto hydrophobic and non-absorbent substrates, for example plastics, metal and glass.

The liquid media may of course contain additional components conventionally used in ink jet printing inks, for example viscosity and surface tension modifiers, corrosion inhibitors, biocides, kogation reducing additives and surfactants which may be ionic or non-ionic.

Further colorants may be added to the ink to modify the shade and performance properties.

It is preferred that the composition according to the invention is ink suitable for use in an ink jet printer. Ink suitable for use in an ink jet printer is ink which is able to repeatedly fire through an ink jet printing head without causing blockage of the fine nozzles. To do this the ink must be particle free, stable (i.e. not precipitate on storage), free from corrosive elements (e.g. chloride) and have a viscosity which allows for good droplet formation at the print head.

Ink suitable for use in an ink jet printer preferably has a viscosity of less than 20 cP, more preferably less than 10 cP, especially less than 5 cP, at 25° C.

Ink suitable for use in an ink jet printer preferably contains less than 500 ppm, more preferably less than 250 ppm, especially less than 100 ppm, more especially less than 10 ppm in total of divalent and trivalent metal ions (other than any divalent and trivalent metal ions bound to a colorant of Formula (1) or any other colourant or additive incorporated in the ink).

Preferably ink suitable for use in an ink jet printer has been filtered through a filter having a mean pore size below 10 μm, more preferably below 3 μm, especially below 2 μm, more especially below 1 μm. This filtration removes particulate matter that could otherwise block the fine nozzles found in many ink jet printers.

Preferably ink suitable for use in an ink jet printer contains less than 500 ppm, more preferably less than 250 ppm, especially less than 100 ppm, more especially less than 10 ppm in total of halide ions.

A fourth aspect of the invention provides a process for forming an image on a substrate comprising applying a composition, preferably ink suitable for use in an ink jet printer, according to the third aspect of the invention, thereto by means of an ink jet printer.

The ink jet printer preferably applies the ink to the substrate in the form of droplets that are ejected through a small orifice onto the substrate. Preferred ink jet printers are piezoelectric ink jet printers and thermal ink jet printers. In thermal ink jet printers, programmed pulses of heat are applied to the ink in a reservoir by means of a resistor adjacent to the orifice, thereby causing the ink to be ejected from the orifice in the form of small droplets directed towards the substrate during relative movement between the substrate and the orifice. In piezoelectric ink jet printers the oscillation of a small crystal causes ejection of the ink from the orifice.

The substrate is preferably paper, plastic, a textile, metal or glass, more preferably paper, an overhead projector slide or a textile material, especially paper.

Preferred papers are plain or treated papers which may have an acid, alkaline or neutral character. Photographic quality papers are especially preferred. Photographic quality paper give a similar finish to that typically seen with silver halide photo printing.

A fifth aspect of the present invention provides a material preferably paper, plastic, a textile, metal or glass, more preferably paper, an overhead projector slide or a textile material, especially paper more especially plain, coated or treated papers printed with an oligomerised dye compound, and salts thereof, as described in the first aspect of the invention, a composition according to the third aspect of the invention or by means of a process according to the fourth aspect of the invention.

It is especially preferred that the printed material of the fifth aspect of the invention is a print on a photographic quality paper printed using a process according to the fourth aspect of the invention.

A sixth aspect of the present invention provides an ink jet printer cartridge comprising a chamber and a composition, preferably ink suitable for use in an ink jet printer, wherein the composition is in the chamber and the composition is as defined and preferred in the third aspect of the present invention. The cartridge may contain a high concentration ink and a low concentration ink, as described in the third aspect of the invention, in different chambers.

The invention is further illustrated by the following Examples in which all parts and percentages are by weight unless otherwise stated.

### EXPERIMENTAL

### Example 1

### Stage 1(a)

### Preparation of Intermediate (1a)

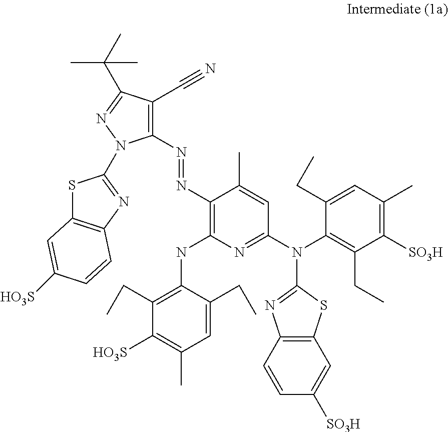

Intermediate 1(a) was prepared as described for Compound d5 of US20060009357 which description is incorporated herein by reference.

### Stage 1 (b)

### Preparation of a Compound of Formula (1)

### Preparation of Intermediate (1b)

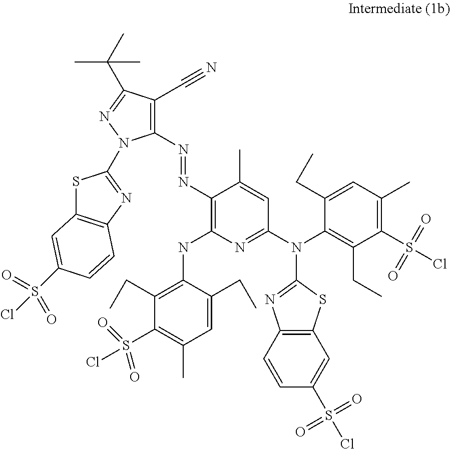

Chlorosulfonic acid (20 mls) was added drop-wise, maintaining the temperature below 35° C., to sulfolane (10 ml). Phosphorus pentoxide (2.8 g, 0.02 mole) was then added while continuing to maintain the temperature at less than 35° C. The mixture was stirred for 5 minutes before adding intermediate 1(a) (5.0 g, 0.0062 mole) in small portions at while keeping the reaction temperature below 35° C. When the addition was complete, the temperature was raised to 100° C. and held there for 4.5 hours. After cooling the reaction mixture to less than 25° C. it was drowned out into ice/water (approximately 300 g). Intermediate 1(b) was collected by filtration and washed with ice cold water (4×200 mls).

### Stage 1 (c)

### Preparation of the Oligomerised Dye

4,4′-Diaminostilbene-2,2′-disulfonic acid (1.4 g (at 85% strength), 0.0031 mole) was slurried in water (100 mls) and dissolved by the addition of 2M lithium hydroxide solution at pH 7. The solution was cooled to <10° C. and the Intermediate 1(b) paste from Stage 1 (b) was added. The mixture was then stirred at below 10° C. for 1 hour, adding 2M lithium hydroxide as required to maintain the pH at 7. The reaction mixture was then allowed to warm to room temperature and the pH was increased to pH 9 with 2M lithium hydroxide solution. The mixture was stirred for 16 hours at room temperature at pH 9 and then raised to pH 12 with 2M lithium hydroxide solution. The product solution was dialysed in Visking tubing to low conductivity, filtered through Whatman GFF paper and evaporated to dryness on a rotary evaporator at 60° C./20 mm Hg to constant weight, yielding 7.9 g product.

### Example 2

The oligomerised dye compound of Example 2 was prepared as described in Example 1 except that in Stage 1(c) 0.19 g of 2,4-diaminobenzenesulfonic acid was used in place of 4,4′-diaminostilbene-2,2′-disulfonic acid as the compound of Formula (2).

### Example 3

### Stage 3 (a)

### Alternative Preparation of Intermediate 1(b)

Intermediate 1(a) (40 g, 0.034 mol) was added to thionyl chloride (235 g) at 0-10° C. DMF (10 ml) was added to the reaction mixture which was stirred and maintained at 0-10° C. for 2 hours. The reaction mixture was then stirred for a further 2 hours at 50° C. before cooling to room temperature and adding to hexane (2000 ml). The precipitate which formed was collected by filtration, dissolved in dichloromethane (500 ml), screened through filter aid and evaporated to leave 44 g of a red solid.

### Stage 3 (b)

### Preparation of the Oligomerised Dye Compound

A mixture of 1,4-diaminobutane (565 mg, 6.4 mmol) and triethylamine (1.3 g, 12.8 mmol) in methanol (1 ml) was added drop wise to a solution of intermediate 1(b) (4.0 g, 3.21 mmol) in methanol (35 ml) at 0 to 5° C. The reaction mixture was stirred for 1 hour at 0 to 5° C. and then for 16 hours at 20° C. The precipitate was removed by filtration and washed with methanol (10 ml). Potassium acetate (2 g) was added to the combined filtrates and washings and the resultant precipitate was collected by filtration, washed with methanol (10 ml) and dried. The crude product was dispersed in water (100 ml) and dialysed to low conductivity. The solution was dried in an oven at 60° C. to give 100 mg of a red solid.

The table below discloses a number of oligomerised dyes, according to the present invention, which could be prepared using analogous processes to those described above.

| Example | | | | | |
|---|---|---|---|---|---|
| Oligomerised | | | | | |
| Dyes | R³ | R¹ | R² | m | Compound of Formula (2) |
| Dye A | t-Butyl | Methyl | Methyl | 4 | 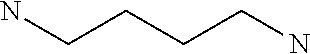 |
| Dye B | t-Butyl | Ethyl | Methyl | 4 | 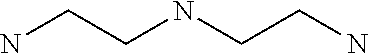 |
| Dye C | t-Butyl | Ethyl | Methyl | 4 | 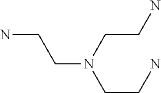 |
| Dye D | t-Butyl | Ethyl | Methyl | 4 | 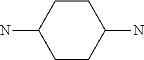 |
| Dye E | t-Butyl | Ethyl | Methyl | 4 | 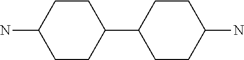 |
| Dye F | t-Butyl | Ethyl | Methyl | 4 | 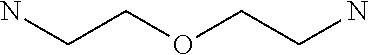 |
| Dye G | t-Butyl | Ethyl | Methyl | 4 | 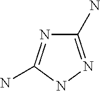 |
| Dye H | t-Butyl | Ethyl | Methyl | 4 | 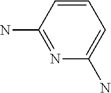 |
| Dye I | t-Butyl | Ethyl | Methyl | 4 | 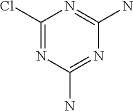 |
| Dye J | t-Butyl | Ethyl | Methyl | 4 | 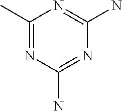 |
| Dye K | 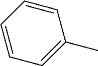 | Methyl | Methyl | 4 | 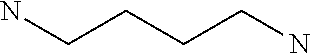 |
| Dye L | 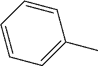 | Ethyl | Methyl | 4 | 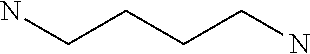 |

### Comparative Dye

The comparative dye was Example 1(a) described as prepared above.

### Example 4

### Preparation of Inks

Ink may be prepared by dissolving 3 parts by weight of the dye of Example 1 in 97 parts by weight of a liquid medium comprising % by weight:

| | |
|---|---|
| Diethylene glycol | 7% |
| Ethylene glycol | 7% |
| 2-Pyrollidone | 7% |
| Surfynol ™ 465 | 1% |
| Tris buffer | 0.2% |
| Water | 77.8% |

and adjusting the pH of the ink to 8-8.5 using sodium hydroxide.

Surfynol® 465 is a surfactant from Air Products.

### Example 5

### Foaming

The oligomerised dye compound prepared in Example 1 and the dye of the Comparative Example were dissolved in water to yield 0.5% solutions. Each solution (2 ml) was placed in a stoppered volumetric flask and the flask was vigorously shaken for 10 seconds. The initial volume of foam and its decay was measured over a two minute period. The results are shown in the table below. Clearly the dyes of the present invention are much less likely to form and stabilise foam. This is of crucial importance in the manufacture and operability of ink jet printing heads.

| | Foam volume (mL) | | | |
|---|---|---|---|---|
| | 0 s | 30 s | 60 s | 120 s |
| Comparative Example 1 | 2.53 | 2.40 | 2.20 | 1.73 |
| Example 18 | 0.33 | 0.27 | 0.27 | 0.20 |

### Further Inks

The inks described in Tables A and B may be prepared using the compound of Example 1. The dye indicated in the first column is dissolved in 100 parts of the ink as specified in the second column on. Numbers quoted in the second column onwards refer to the number of parts of the relevant ink ingredient and all parts are by weight. The pH of the ink may be adjusted using a suitable acid or base. The inks may be applied to a substrate by ink jet printing.

The following abbreviations are used in Tables A and B:

PG=propylene glycol

DEG=diethylene glycol

NMP=N-methylpyrrolidone

DMK=dimethylketone

IPA=isopropanol

2P=2-pyrrolidone

MIBK=methylisobutyl ketone

P12=propane-1,2-diol

BDL=butane-2,3-diol

TBT=tertiary butanol

TABLE A

| Dye | Water | PG | DEG | NMP | DMK | IPA | 2P | MIBK |
|---|---|---|---|---|---|---|---|---|
| 2.0 | 80 | 5 | | 6 | 4 | | 5 | |
| 3.0 | 90 | | 5 | 5 | | | | |
| 10.0 | 85 | 3 | | 3 | 3 | | 6 | |
| 2.1 | 91 | | 8 | | | | | 1 |
| 3.1 | 86 | 5 | | | | 4 | | 5 |
| 1.1 | 81 | | | 9 | | | 10 | |
| 2.5 | 60 | 4 | 15 | 3 | 3 | 6 | 5 | 4 |
| 5 | 65 | | 20 | | | 10 | 5 | |
| 2.4 | 75 | 5 | 10 | | 5 | | | 5 |
| 4.1 | 80 | 3 | 5 | 2 | 10 | | | |
| 3.2 | 65 | | 5 | 4 | 6 | 5 | 10 | 5 |
| 5.1 | 96 | | | | | | 4 | |
| 10.8 | 90 | 5 | | | | 5 | | |
| 10.0 | 80 | 2 | 6 | 2 | 5 | 1 | 4 | |
| 1.8 | 80 | | 5 | | | | 15 | |
| 2.6 | 84 | | | 11 | | | 5 | |
| 3.3 | 80 | 4 | | | 10 | | | 6 |
| 12.0 | 90 | | | | 7 | 3 | | |
| 5.4 | 69 | 2 | 20 | 2 | 1 | | 3 | 3 |
| 6.0 | 91 | | | 4 | | | 5 | |

TABLE B

| Dye | Water | PG | DEG | NMP | TBT | BDL | PI2 |
|---|---|---|---|---|---|---|---|
| 3.0 | 80 | 20 | | | | | |
| 9.0 | 90 | | 5 | | | | 5 |
| 1.5 | 85 | 5 | 5 | | 5 | | |
| 2.5 | 90 | | 6 | 4 | | | |
| 3.1 | 82 | 4 | 8 | | | | 6 |
| 0.9 | 85 | | 10 | | | 5 | |
| 8.0 | 90 | | 5 | 5 | | | |
| 4.0 | 70 | | 10 | 4 | | 5 | 11 |
| 2.2 | 75 | 10 | 10 | 3 | | 2 | |
| 10.0 | 91 | | | 9 | | | |
| 9.0 | 76 | | 9 | 7 | 3 | 5 | |
| 5.0 | 78 | 5 | 11 | | | 6 | |
| 5.4 | 86 | | | 7 | 7 | | |
| 2.1 | 70 | 5 | 10 | 5 | 5 | 5 | |
| 2.0 | 90 | | 10 | | | | |
| 2 | 88 | | 12 | | | | |
| 5 | 78 | | | 5 | | 7 | 10 |
| 8 | 70 | 2 | 20 | 8 | | | |
| 10 | 80 | 10 | 10 | | | | |
| 10 | 80 | | 20 | | | | |

1. An oligomerised dye compound, and salts thereof, obtainable by a process which comprises reacting a compound of Formula (1) and salts thereof with a compound of Formula (2) and salts thereof 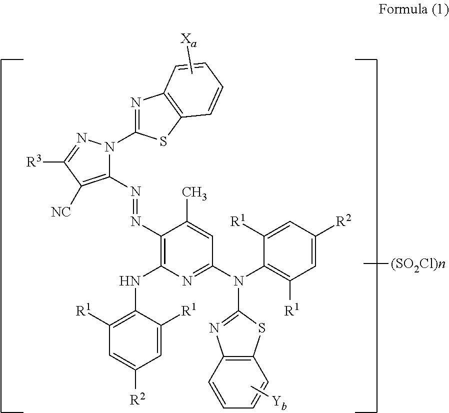
wherein:
R¹ and R² are independently H, optionally substituted alkyl, optionally substituted aryl or optionally substituted heteroaryl;
R³ is optionally substituted alkyl, optionally substituted aryl or optionally substituted heteroaryl;
X and Y are independently a substituent;
a+b=0 to 4;
n is 4 to 6;
L-(NH₂)ₘ Formula (2)
wherein:
L comprises an optionally substituted, or optionally interrupted, aliphatic group, an optionally substituted aromatic group or an optionally substituted heterocyclic group; and
m is 2 to 4.

2. An oligomerised dye compound, and salts thereof as claimed in claim 1 wherein R¹ and R² are independently H or optionally substituted alkyl.

3. An oligomerised dye compound, and salts thereof as claimed in claim 1 wherein R¹ is methyl or ethyl.

4. An oligomerised dye compound, and salts thereof as claimed in claim 1 wherein R² is methyl.

5. An oligomerised dye compound, and salts thereof as claimed in claim 1 wherein R³ is optionally substituted C₁₋₄alkyl.

6. An oligomerised dye compound, and salts thereof as claimed in claim 1 wherein X and Y are independently selected from the group consisting of —Cl, —CN, —CF₃, and —SO₂R⁴ wherein R⁴ is optionally substituted alkyl; optionally substituted aryl; or optionally substituted heterocyclyl.

7. (canceled)

8. An oligomerised dye compound, and salts thereof as claimed in claim 1 wherein m is 2.

9. An oligomerised dye compound, and salts thereof as claimed in claim 8 wherein L comprises; a linear, cyclic or branched optionally substituted C₁₋₂₀alkylene optionally interrupted with 1 to 8 hetero atoms; optionally substituted phenylene; optionally substituted naphthylene; or an optionally substituted 5- to 8-membered heterocyclylene with 1 to 3 hetero atoms wherein the hetero atoms are N and/or O.

10. An oligomerised dye compound, and salts thereof as claimed in claim 1 obtainable by a process which comprises reacting a compound of Formula (1 a) and salts thereof with a compound of Formula (2a) and salts thereof 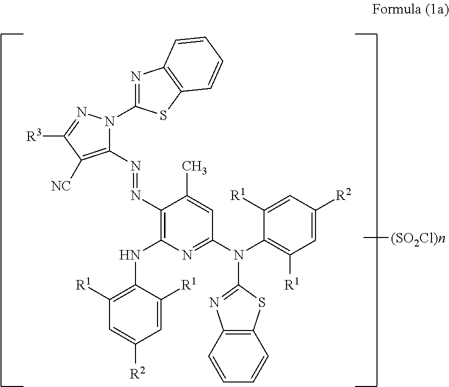
wherein:
R¹ and R² are independently H or optionally substituted C₁₋₄alkyl;
R³ is optionally substituted C₁₋₄alkyl, optionally substituted phenyl or optionally substituted naphthyl; and
n is 4 to 6;
L¹-(NH₂)₂ Formula (2a)
wherein:
L is a linear, cyclic or branched optionally substituted C₁₋₂₀alkylene optionally interrupted with 1 to 4 hetero atoms; optionally substituted phenylene; optionally substituted naphthylene; or an optionally substituted 5- to 8-membered heterocyclylene.

11. A process for preparing an oligomerised dye compound, and salts thereof, which comprises reacting a compound of Formula (1) and salts thereof with a compound of Formula (2) and salts thereof 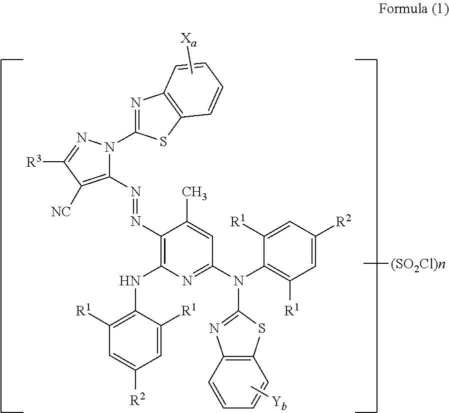
wherein:
R¹ and R² are independently H, optionally substituted alkyl, optionally substituted aryl or optionally substituted heteroaryl;
R³ is optionally substituted alkyl, optionally substituted aryl or optionally substituted heteroaryl;
X and Y are independently a substituent;
a+b=0 to 4;
n=4 to 6;
L-(NH₂)ₘ Formula (2)
wherein:
L comprises an optionally substituted, or optionally interrupted, aliphatic group, an optionally substituted aromatic group or an optionally substituted heterocyclyl group; and
m is 2 to 4.

12. A composition comprising an oligomerised dye compound, and salts thereof, as described in claim 1, and a liquid medium.

13. A process for forming an image on a substrate comprising applying a composition according to claim 12, thereto by means of an ink jet printer.

14. A material printed with an oligomerised dye compound, and salts thereof as described in claim 1.

15. An ink jet printer cartridge comprising a chamber and a composition according to claim 12, wherein the composition is in the chamber.
